(19) United States
(12) Patent Application Publication
(10) Pub. No.: US 2024/0320324 A1
(43) Pub. Date: Sep. 26, 2024

(54) APPARATUS, METHOD, AND SYSTEM FOR SCHEDULING APPLICATION UNITS UTILIZING TRUSTED EXECUTION ENVIRONMENTS IN COMPUTING CLUSTERS

(71) Applicant: Intel Corporation, Santa Clara, CA (US)

(72) Inventor: Ziye YANG, Shanghai (CN)

(21) Appl. No.: 18/680,159

(22) Filed: May 31, 2024

(30) Foreign Application Priority Data
Aug. 10, 2023 (WO) PCT/CN2023/112630

(51) Int. Cl. G06F 21/53; G06F 21/54

(52) U.S. Cl. CPC G06F 21/53; G06F 21/54

(57) ABSTRACT

A method, system, and apparatus for deploying application units within a computing cluster is disclosed. The apparatus includes memory circuitry, machine-readable instructions, and processor circuitry configured to identify a plurality of worker nodes, each with a hardware-based security resource. The apparatus receives deployment requests specifying security requirements, selects compatible worker nodes based on these requirements, and schedules the application units for execution on the selected nodes.

### CROSS-REFERENCE TO RELATED APPLICATION

This application claims priority to PCT Application PCT/CN2023/112630 filed in the Chinese Receiving Office on Aug. 11, 2023. The contents of this earlier filed application is incorporated by reference herein in its entirety.

### BACKGROUND

In modern distributed computing environments, deploying application units such as pods and containers requires precise scheduling to ensure security and efficiency. Traditional scheduling mechanisms do not incorporate hardware-based security resources like Trusted Execution Environments (TEEs), leading to potential security vulnerabilities and inefficient resource utilization. Existing systems typically rely on simple labeling, which does not account for the dynamic nature of resource availability and specific security requirements of applications. Therefore, there may be a desire for a fine-grained scheduling apparatus that dynamically tracks and manages security resources across a cluster.

### BRIEF DESCRIPTION OF THE FIGURES

Some examples of apparatuses and/or methods will be described in the following by way of example only, and with reference to the accompanying figures, in which

FIG. 1 shows a block diagram of an example of an apparatus or device for a scheduler apparatus and a worker apparatus in a cluster;

FIG. 2 shows an example hardware TEE-based fine-grained scheduler;

FIG. 3 shows an application of the example schemes disclosed herein into K8s;

FIG. 4 shows an example of TEE resource change inside schedulers;

FIGS. 5A and 5B show a flowchart of a method for a scheduler node and a worker node in a cluster;

FIG. 6 is a block diagram of an electronic apparatus incorporating at least one electronic assembly and/or method described herein;

FIG. 7 illustrates a computing device in accordance with one implementation of the invention; and

FIG. 8 shows an example of a higher-level device application for the disclosed embodiments.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures, same or similar reference numerals refer to same or similar elements and/or features, which may be identical or implemented in a modified form while providing the same or a similar function. The thickness of lines, layers, and/or areas in the figures may also be exaggerated for clarification.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

When two elements A and B are combined using an “or,” this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a,” “an,” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include,” “including,” “comprise,” and/or “comprising,” when used, describe the presence of the specified features, integers, steps, operations, processes, elements, components, and/or a group thereof, but do not exclude the presence or addition of one or more other features, integers, steps, operations, processes, elements, components and/or a group thereof.

Unless otherwise defined, all terms (including technical and scientific terms) are used herein in their ordinary meaning of the art to which the examples belong.

Specific details are set forth in the following description, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply that the described element item must be in a given sequence, either temporally or spatially, in ranking, or in any other manner. “Connected” may indicate elements are in direct physical or electrical contact with each other, and “coupled” may indicate elements cooperate or interact with each other, but they may or may not be in direct physical or electrical contact.

As used herein, the terms “operating,” “executing,” or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

It should be noted that the example schemes disclosed herein are applicable for/with any operating system and a reference to a specific operating system in this disclosure is merely an example, not a limitation.

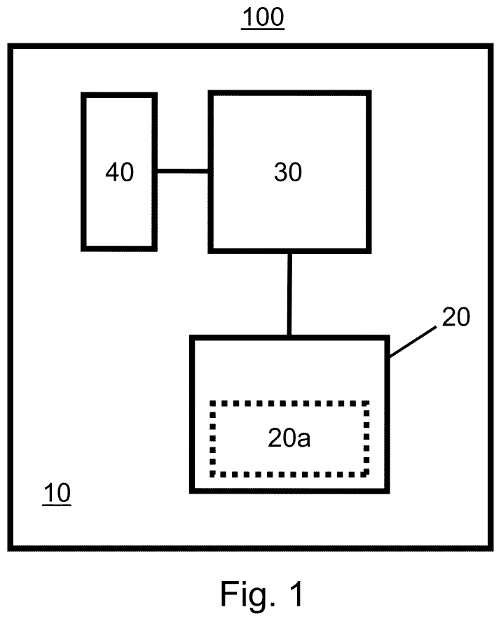

FIG. 1 illustrates a block diagram of an apparatus 100 or device 100 example. Apparatus 100 comprises circuitry configured to provide the functionality of the apparatus 100. For example, apparatus 100 of FIG. 1 comprises interface circuitry 40, processing circuitry 30, (optional) storage circuitry 20, and machine-readable instructions 20a. For example, the processing circuitry 30 may be coupled with the interface circuitry 40 and optionally with the storage circuitry 20.

For example, the processing circuitry 30 may be configured to provide the functionality of the apparatus 100 in conjunction with the interface circuitry 40. For example, the interface circuitry 40 may be configured to exchange information, e.g., with other components inside or outside the apparatus 100 and the storage circuitry 20. Likewise, the device 100 may comprise means that is/are configured to provide the functionality of the device 100.

The components of the device 100 are defined as component means, which may correspond to, or be implemented by, the respective structural components of the apparatus 100. For example, device 100 of FIG. 1 comprises means for processing 30, which may correspond to or be implemented by the processing circuitry 30, means for communicating 40, which may correspond to or be implemented by the interface circuitry 40, and (optional) means for storing information 20, which may correspond to or be implemented by the storage circuitry 20. In the following, the functionality of the device 100 is illustrated with respect to the apparatus 100. Features described in connection with the apparatus 100 may thus likewise be applied to the corresponding device 100.

In general, the functionality of the processing circuitry 30 or means for processing 30 may be implemented by the processing circuitry 30 or means for processing 30 executing machine-readable instructions. Accordingly, any feature ascribed to the processing circuitry 30 or means for processing 30 may be defined by one or more instructions of a plurality of machine-readable instructions. The apparatus 100 or device 100 may comprise the machine-readable instructions, e.g., within the storage circuitry 20 or means for storing information 140.

The interface circuitry 40 or means for communicating 40 may correspond to one or more inputs and/or outputs for receiving and/or transmitting information, which may be in digital (bit) values according to a specified code, within a module, between modules or between modules of different entities. For example, the interface circuitry 40 or means for communicating 120 may comprise circuitry configured to receive and/or transmit information.

For example, the processing circuitry 30 or means for processing 30 may be implemented using one or more processing units, one or more processing devices, or any means for processing, such as a processor, a computer, or a programmable hardware component being operable with accordingly adapted software. In other words, the described function of the processing circuitry 30 or means for processing 30 may be implemented in software, which is then executed on one or more programmable hardware components. Such hardware components may comprise a general-purpose processor, a Digital Signal Processor (DSP), a microcontroller, etc.

For example, the storage circuitry 20 or means for storing information 20 may comprise at least one element of the group of a computer-readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage. For example, the storage circuitry 20 may store a (UEFI) BIOS.

The memory circuitry 20 may be a non-transitory, computer-readable medium comprising a program code 20a that, when the program code 20a is executed on a processor, a computer, or a programmable hardware component 30, causes the processor, computer, or programmable hardware component 30 to perform the embodiments disclosed herein.

The processing circuitry 30 may be configured to identify a plurality of worker nodes within a cluster, where each worker node comprises a hardware-based security resource. Processing circuitry 30 may further receive a deployment request for an application deployment unit, wherein the deployment request includes a security requirement for a type of hardware-based security resource. Then, processing circuitry 30 may select, based on the security requirement, a compatible worker node of the plurality of worker nodes, wherein the compatible worker node comprises the type of hardware-based security resource. Finally, processing circuitry 30 may schedule the application deployment unit for execution on the compatible worker node.

A scheduling apparatus may comprise memory circuitry, machine-readable instructions, and processor circuitry configured to perform scheduling tasks. A worker node may be a computing node within a cluster that can execute application deployment units. An application deployment unit may be a software package ready for deployment, such as a pod or container.

The hardware-based security resource may be a trusted execution environment (TEE). A hardware-based security resource may be a physical component that provides security functionalities, such as a TEE. A TEE may be a secure processor area that ensures the integrity and confidentiality of code and data loaded inside. The scheduling apparatus of FIG. 1 may ensure that applications requiring specific security features are only deployed on compatible nodes, thereby enhancing the security of the deployed applications by leveraging available hardware-based security resources. Using a TEE as the hardware-based security resource ensures that the deployment takes advantage of the highest level of hardware security available.

A cluster may comprise a plurality of types of TEEs. A cluster is a collection of interconnected computers, known as nodes, that work together as a single system to provide high availability, scalability, and performance. Each node of the cluster may have one or more types of TEEs. In computing and data processing, a cluster is designed to distribute workloads across multiple machines to improve efficiency, reliability, and redundancy. There are various types of TEEs, including SGX, SEV, TrustZone, TDX, CCA, etc. SGX (Software Guard Extensions) is a set of security-related instruction codes built into some modern CPUs, providing enclaves for secure computation. SEV (Secure Encrypted Virtualization) is a feature of some processors that encrypts virtual machines' memory to protect against unauthorized access. TrustZone is a security extension integrated into some processors that creates an isolated secure world alongside the normal execution environment. TDX (Trusted Domain Extensions) is an extension of virtualization technology that provides hardware-enforced confidentiality and integrity protections for virtual machines. CCA (Confidential Compute Architecture) is an architecture designed to secure sensitive data and code execution within a hardware-isolated environment on certain processors.

The application deployment unit may be a pod or a container. This ensures that the scheduling apparatus can handle different application deployment units, providing versatility in deploying a wide range of applications. Pod or container orchestration systems are platforms designed to automate containers' deployment, scaling, management, and networking across clusters of machines. These systems ensure efficient resource utilization, high availability, and fault tolerance by scheduling containers to run on suitable nodes based on resource requirements and availability. They provide features like service discovery, load balancing, automated rollouts and rollbacks, and storage orchestration. By abstracting the underlying infrastructure, container orchestration systems enable developers to focus on application development while maintaining consistent and reliable operations in diverse computing environments. Examples include Kubernetes (K8s), Docker Swarm, Apache Mesos, and HashiCorp Nomad.

A pod is a lightweight, portable, and self-sufficient computing environment that encapsulates one or more applications and their dependencies. It provides a consistent runtime environment, ensuring applications run reliably across different computing environments. Within a pod, containers share the same network namespace and storage resources, allowing them to communicate easily and share data.

A container is a standardized unit of software that packages up code and all its dependencies so the application runs quickly and reliably from one computing environment to another. Containers and the host system are isolated from one another, ensuring each container operates in its own environment with its own file system, CPU, memory, and process space. This isolation provides consistency, security, and portability across different infrastructure environments, whether on-premises or in the cloud.

Certain platforms, like K8s, automate the deployment, scaling, and management of containerized applications. They manage clusters of virtual machines and schedule containers to run on those clusters based on their available computing resources and the application's requirements.

The examples disclosed herein address the pod or container scheduling in a cluster that relies on hardware-based TEE resources. The present disclosure treats hardware-based TEE info in each node as security resources and dynamically tracks those resources. Pods or containers may be scheduled with TEE-related requirements with an enhanced scheduler. The TEE resources may be dynamically tracked or monitored by the control plane or notified by the scheduler in the cluster. Then, these security resources could be scheduled even with quality of service (QOS) purposes.

The scheduler apparatus 100 receives worker node data from the plurality of worker nodes within the cluster. Worker node data is information about each worker node, including its available resources and capabilities. This enables the apparatus to gather detailed information from each worker node, which can be used to make informed and fine-grained scheduling decisions.

The Apparatus 100 discloses a fine-grained scheduler based on collected TEE resources. The collected hardware-TEE resources are utilized in the scheduler to enhance the scheduling; thus, the pods or containers may be scheduled accurately. With this approach, the failure of pods or containers to start at the destination or working node may be prevented.

Schedulers are challenged when integrating nodes with hardware-based tee resources into the cluster because the security components are not treated as schedulable or first-class citizen resources for scheduling. The cluster's orchestration components or control planes will not treat hardware TEE resources in each node as resources. So, the current scheduler based on hardware-based TEE resources is very simple. For example, in K8s, there are two main solutions. First, a label-based scheduler, where the K8s labels each node with SGX or TDX label for the node, then schedules the pods or containers according to a user's YAML file (a configuration file). YAML (YAML Ain′t Markup Language) is a human-readable data serialization format commonly used to configure files and exchange between languages with different data structures. YAML is designed to be easy to read and write, making it ideal for configuration management, data interchange, and application storage. However, any machine or human-readable format can be used for a deployment request, allowing flexibility in specifying application requirements and configurations. And second, a scheduler based on extended resources.

However, K8s can use a device plugin framework to manage the device numbers in each host and then schedule the pods or containers according to the explicit TEE resource description. The resource tracking for the TEE resources is not accurate. Because the resource report is one-time and static, this will not correctly guide the scheduler. It may fail to schedule the pods due to the unchanged old info. Because the pods or containers will need additional security resources to start instead of only device numbers. For example, EPC (enclave page cache) is required for SGX; available TDX keys and memories are necessary for starting pods with TDX-protected virtual machines (VMs, i.e., TD-VMs).

Usually, hardware-based TEE-related components are not treated as security resources. Currently, in the popular project K8s, there are two kinds of schedulers: First, a label-based scheduler. This means that the scheduler can schedule the pods or containers to a node with the predefined label on that node. For example, if a node is labeled with SGX/TDX info, the pods with the required label in their YAML files will be scheduled to those nodes.

Second, a scheduler based on extended resources. Each node can have some extended resource info. Then, the scheduler receives the request to schedule the pods with the extended resource in the YAML files, which will be scheduled with the extended resources. For example, if there is 1 SGX device request in the YAML file, the scheduler will schedule the pods into the node with SGX devices discovered previously by the device plugin work.

The existing two schedulers in K8s-managed distributed clusters are inaccurate. The scheduler is not aware of the TEE-based security resource. So, pod scheduling is quite simple and coarse-grained. A pod with containers scheduled into a destination host may not start due to a shortage of resources. Then, there will be many paused pods, and rescheduling is needed. Even rescheduling cannot address this issue.

The examples disclosed herein address the scheduling of application deployment units within a cluster (e.g., pods or containers), which require hardware-based TEE resources. To do this, the system should first treat hardware-based TEE info in each node as security resources to start pods or containers and these resources. Those resources will be dynamically tracked/monitored by the control plane or notified by the scheduler in the cluster. Then, these security resources could be scheduled even with QoS purposes.

And second, the system should employ a fine-grained scheduler based on collected TEE resources. The disclosed embodiments utilize the collected hardware-based TEE resources in the scheduler and enhance the scheduling. Thus, the pods or containers may be scheduled accurately. The disclosed approach can prevent the failure of pods to start at the destination node.

The hardware-based TEE technique (e.g., SGX/TDX) may be fully exploited with the example schemes disclosed herein in cluster usage. With the disclosed example schemes, the multiple tenancy usage based on SGX/TDX may be explored well, and the techniques disclosed herein may continue to be promoted. There is a service to remotely verify and assert the trustworthiness of computing assets (TEEs, devices, Root of Trusts). For example, the hardware-based TEE-related resources in each node may be collected and used for scheduler usage. The disclosed examples may provide the TEE or host-related attestation and each node's dynamic TEE resource change to the orchestrator.

Users may manage the TEE resource in a fine-grained manner. The disclosed embodiments may efficiently schedule the pods or containers and then efficiently use the nodes with TEE resources. They can decrease their TCO.

In the disclosed examples, hardware-based TEE components and related resources from each node in the cluster may be treated as security resources, which may be managed by the control plane in the cluster and aware by the scheduler in the cluster.

Worker node data may include the type of hardware-based security resource, a trusted memory size, the number of devices, and the number of supported keys. Trusted memory size may be the amount of secure memory available on a node. The number of devices may be the count of hardware security modules or processors with TEEs. The number of supported keys may be the number of cryptographic keys that the security resource can manage. This embodiment allows for more detailed and granular data collection, ensuring the scheduler has all the necessary information to optimize security and resource allocation.

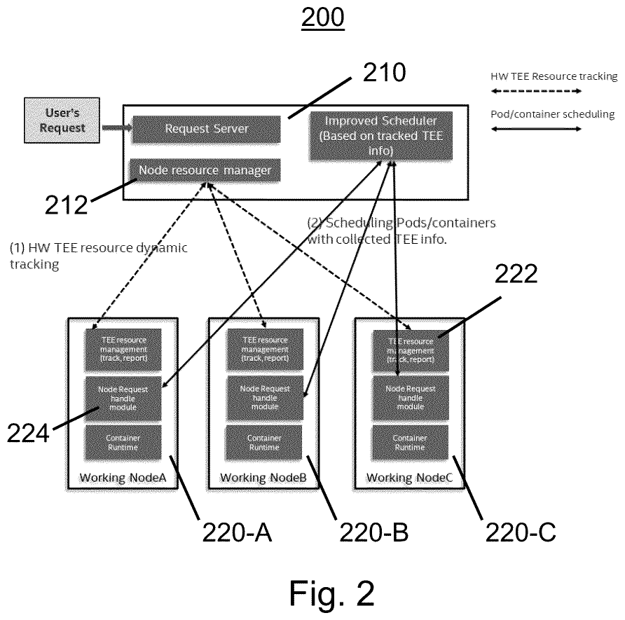

FIG. 2 shows diagram 200 of an example fine-grained scheduler for a hardware-based TEE. The main idea may be composed of the following two parts:

First, the embodiments are described for dynamically tracking and monitoring hardware TEE resources. As shown in FIG. 2, the TEE resource in each working node 220-A, 220-B, 220-C may be managed by the TEE resource management module 222 in each node, and it should be reported to the node resource manager 212 of the scheduler apparatus or scheduling node 210. An example of a TEE resource is defined in Table 1. Table 1 shows an example of the definition of hardware TEE. The structure may be defined as 4 KB (or 1 KB, or 2 KB, or 8 KB, or 32 KB, etc.) or a similar size. This structure may be extended with more fields if different hardware TEEs are available.

```
TABLE 1
/* These fields in this structure are used to track the TEE resource */
Struct Tee_resources
{
/* This field is designed to store the TEE type. For example, value 0 may be used to
represent SGX; value 1 can present TDX; */
  Uint16_t TEE_type;
/* This field is used to store the protected memory size in MB related with this TEE
module. For example, if TEE_type is SGX, then the memory_size should be
interpreted as the EPC memory size. If the TEE_type is TDX, it should be interpreted
as TD's trusted memory.
*/
  Uint64_t trusted_memory_size;
/*This field is used to track the total available device numbers in this platform */
  Uint32_t num_devces;
/*This field defines the supported key numbers to protect the memories in this
platform */
Uin32_t supported_key_nums;
/* Customized fields for a special TEE */
Char custom_fields[1024];
};
```

According to Table 1, a node's TEE resources may be reported to the node source manager in the scheduler node 210. Moreover, each node has a TEE-based event monitor module to track the available TEE resources. This is one of the key innovations which can differentiate existing solutions. For example, if working node-A 220-A in FIG. 2 has the following security TEE resources,
<TEE_TYPE=SGX, trusted_memory_size=8 GB, num_devices=4, supported_key_nums=16, . . . >.

Then, the EPC size of the node is added with another 8 GB. Then, the node resource manager should have the following TEE info of the working node A 220-A in FIG. 2. For example,
<TEE_TYPE=SGX, trusted_memory_size=16 GB, num_devices=4, supported_key_nums=16, . . . >.

This means that if there are dynamic changes in the TEE in each node, the node resource manager will always get the latest info from the corresponding TEE resource management module and adjust the scheduler. This means there will always be an event to promote the TEE resource change info from the working node to the scheduler apparatus 210. Moreover, the working nodes 220-A, 220-B, 220-C in FIG. 2 may be an Xeon host and an IPU. When a new working node is added to the cluster, the scheduler node may do an attestation.

The scheduler apparatus 220 may update the worker node data based on a change in the hardware-based security resource in each worker node. This ensures worker node data is continuously updated, maintaining the accuracy of the scheduler's decisions based on the most current resource availability.

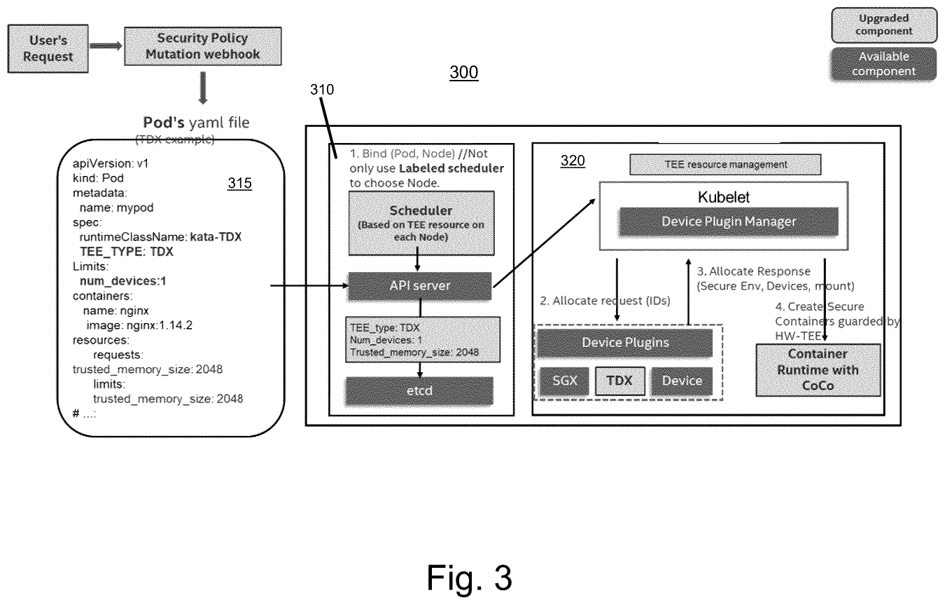

FIG. 3 shows an improved scheduler based on the collected hardware-based TEE resource pool and users' request 300. According to the embodiments disclosed herein, by defining TEE resources, the scheduler apparatus 310 can have the TEE resource of each node. Then, the scheduler can use such info to design a more fine-grained scheduler based on the TEE resources. Usually, the simplest algorithm may be matching the fields by order. For example, the apparatus can map the first field (i.e., TEE_EXAMPLE) and then use SQL-like language to select the destination node if Etcd-like databases are used. Etcd-like databases may refer to distributed, key-value stores designed to reliably store data across a cluster of machines, ensuring data consistency and availability. These databases are often used for configuration management, service discovery, and coordination in distributed systems. They provide strong consistency guarantees, allowing clients to read the most recent data written to any node in the cluster, and typically support features such as leader election, distributed locking, and watch mechanisms for real-time updates. After the accurate matching, the related resource numbers may be reduced.

For example, Table 2 shows example TEE resource info of each node.

TABLE 2

| Node | TEE Resource Info |
|---|---|
| Working | <TEE_TYPE=SGX, trusted_memory_size=8GB, |
| Node A | num_devices=4, supported_key_nums=16,..> |
| Working | <TEE_TYPE=TDX, trusted_memory_size=32GB, |
| Node B | num_devices=16, supported_key_nums=16,..> |
| Working | <TEE_TYPE=SGX, trusted_memory_size=32GB, |
| Node C | num_devices=3, supported_key_nums=16,..> |

FIG. 3 further shows a user request coming for the pod, with the following requested info defined in the YAML file,
<TEE_TYPE=SGX, trusted_memory_size=16 GB, num_device=1>.

Without the scheduling disclosed herein, the pod may be scheduled into Node A with a 50% probability if we only leverage the labeled scheduler. But with the algorithms disclosed herein, it will be accurately scheduled into working Node C.

After starting the pods, the resources will be changed into Table 3. When the pods are destroyed, the resources will be converted to the value shown in Table 2. Table 3 shows an example of the TEE resource info of each node after the scheduling.

TABLE 3

| Node | TEE Resource Info |
|---|---|
| Working Node A | <TEE_TYPE=SGX, |
| | trusted_memory_size=8GB, |
| | num_devices=4, |
| | supported_key_nums=16,..> |
| Working Node B | <TEE_TYPE=TDX, |
| | trusted_memory_size=32GB, |
| | num_devices=16, |
| | supported_key_nums=16,..> |
| Working Node C | <TEE_TYPE=SGX, |
| | trusted_memory_size=16GB, |
| | num_devices=2, |
| | supported_key_nums=15,..> |

FIG. 3 shows a deployment request 315 in the form of a pod YAML file describing the pod requirements.

The requested info is: <TEE_TYPE=TDX, num_device=1, trusted_memory_size=2048M>. Then, the scheduler apparatus 310 already applies the schedule, leverages the request interpreted from the YAML file and provides it to the scheduler as described above. In subsequent steps, scheduler apparatus 310 may allocate the related resources successfully and create the containers with the TDX TEE protection.

According to another embodiment, the scheduler apparatus may receive security resource data from the compatible worker node after scheduling the application deployment unit. Security resource data may be information about the current state and usage of security resources on a node. Obtaining this data ensures that the scheduler can monitor the security resource usage after deployment, maintaining the application's security and performance.

According to another embodiment, the scheduler may reschedule the application deployment unit for execution on a second compatible worker node of the plurality of worker nodes when the security resource data no longer satisfies the security requirement. This may provide a mechanism for rescheduling applications if the security resources on a node change, ensuring continuous compliance with security requirements.

When the scheduler selects a working node, the node accepts the request via the node request handle module 224, as shown in FIG. 2. If there is a TEE resource change after the scheduler selects this node. If the node does not have enough resources to execute the application deployment unit, it will notify the scheduler immediately for rescheduling purposes. This may eliminate the failure to start an application deployment unit or pod.

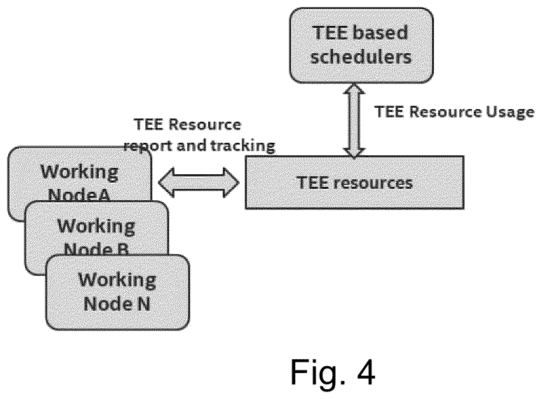

FIG. 4 shows an example of TEE resource change inside schedulers. The scheduler apparatus may further receive cluster data, wherein the cluster data includes an addition of a new worker node to the cluster and/or a removal of an existing worker node from the cluster. Cluster data may include information about the state of the cluster, including changes in the composition of worker nodes. This may allow the scheduler to adapt to changes in the cluster, such as adding or removing nodes, ensuring dynamic and flexible scheduling.

Adding or removing a working node can change the collected hardware TEE resources. When a working node with a TEE resource is added, then a new TEE resource with this node should be added to the node resource manager. This may be done by the worker node reporting itself to the cluster or scheduler node. When a working node is removed from the cluster, the related TEE resource node in the node resource manager should be removed. This may be done by either an active report by the departing worker node or a passive cluster survey. When there is a dynamic change of a TEE resource in a worker node, the worker node should report the change so that the TEE resource state changes in the node resource manager of the scheduler node.

When an application deployment unit (e.g., pod or container) with a TEE resource request is created in the scheduler, the resource state for a working node that will serve the unit is reduced. When the pod with a TEE resource request is destroyed, the resource state for the working node that served the unit is increased.

According to another embodiment, the deployment request may include a trusted memory size, a number of devices, and a number of supported keys. This may provide for the specification of detailed security requirements in the deployment request, allowing for a more precise matching of application needs with node capabilities.

According to another embodiment, a subset of the plurality of worker nodes may comprise a plurality of hardware-based security resources. This may allow for the deployment of applications on nodes with multiple hardware-based security resources or TEEs, enhancing the flexibility and robustness of the scheduling apparatus.

FIG. 1 further shows a worker apparatus 100. The worker apparatus 100 may include memory circuitry, one or more hardware-based security resources, machine-readable instructions, and processor circuitry to execute the machine-readable instructions. The worker apparatus may provide security resource data for each of the one or more hardware-based security resources to a scheduling node and receive an application deployment unit for execution on a compatible hardware-based security resource of the one or more hardware-based security resources.

A worker apparatus may be a computing device within a cluster that provides security resources and executes scheduled applications. This may enable worker nodes to provide up-to-date security resource information to the scheduler, facilitating informed and accurate scheduling decisions.

A worker apparatus 100 may further provide updated hardware-based security resource data for each hardware-based security resource. This may ensure that worker nodes continuously update their security resource data, maintaining the accuracy of the scheduler's information.

A worker apparatus 100 may further determine whether the application deployment unit can execute in the compatible hardware-based security resource and notify the scheduling node when the application deployment unit cannot execute in the compatible hardware-based security resource. This may allow worker nodes to verify whether they can meet the security requirements of the application deployment unit, improving reliability and reducing deployment failures.

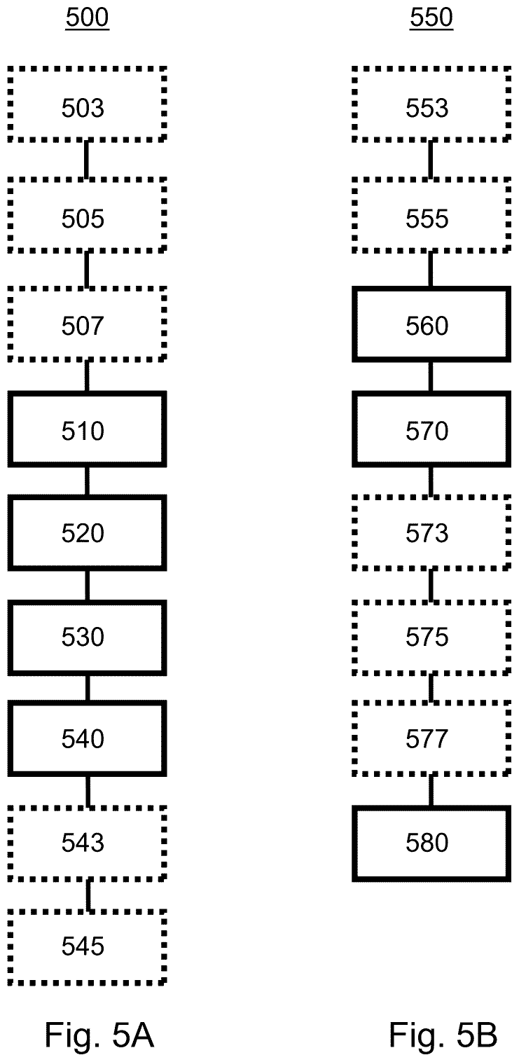

More details and aspects of the concept for offloading a workload may be described in connection with examples discussed below (e.g., FIGS. 5A-8).

FIGS. 5A and 5B show a flowchart of a method for a scheduler node and a worker node in a cluster. FIG. 5A shows method 500 for scheduling an application deployment unit on a compatible worker node within a cluster. The method may include identifying 510, a plurality of worker nodes within a cluster, where each worker node comprises a hardware-based security resource. Method 500 may then include receiving 520 a deployment request for the application deployment unit, wherein the deployment request includes a security requirement for a type of hardware-based security resource;

Method 500 may then include selecting 520, based on the security requirement, the compatible worker node of the plurality of worker nodes, wherein the compatible worker node comprises the type of hardware-based security resource. Finally, method 500 may include scheduling 540, the application deployment unit, for execution on the compatible worker node.

Method 500 may include receiving 505 worker node data from the plurality of worker nodes within the cluster and updating 507 the worker node data based on a change of the hardware-based security resource in each worker node.

Method 500 may include receiving 503 cluster data, wherein the cluster data includes an addition of a new worker node to the cluster and/or a removal of an existing worker node from the cluster. Method 500 may include receiving 543 security resource data from the compatible worker node after scheduling the application deployment unit. Method 500 may include rescheduling 545, the application deployment unit, for execution on a second compatible worker node of the plurality of worker nodes, when the security resource data no longer satisfies the security requirement.

FIG. 5B shows method 550 for executing an application deployment unit on a worker apparatus. Method 550 includes providing 560 security resource data for each of the one or more hardware-based security resources to a scheduling node, which receives 570 in an application deployment unit for execution on a compatible hardware-based security resource of the one or more hardware-based security resources.

The method 550 may include providing 555 updated hardware-based security resource data for each hardware-based security resource. Method 500 may further include determining 575 whether the application deployment unit can execute in the compatible hardware-based security resource and notifying 577 the scheduling node when the application deployment unit cannot execute in the compatible hardware-based security resource.

Method 550 may include notifying 553 the scheduling node when the worker apparatus is added to the cluster and/or when the worker apparatus leaves the cluster. Method 550 may include providing 573 security resource data after receiving the application deployment unit. Method 550 may further include executing 580, the application deployment unit in the hardware-based security resource

The example schemes in this disclosure are to treat hardware-based TEE in each node as a security resource, and the pods or containers scheduler in the cluster may be aware of those hardware-based TEE resources accurately and dynamically. Then, a fine-grained scheduler may be provided based on the HW TEE resources according to the requirements of users' pods or containers, and even conduct the QoS on security resources (e.g., TEE resources). With the example schemes disclosed herein, the scheduler is much more efficient than the existing approaches (e.g., the label-based scheduler or extended resource scheduler in K8s). Promoting SGX/TDX-based TEE techniques in confidential container usage scenarios will be helpful.

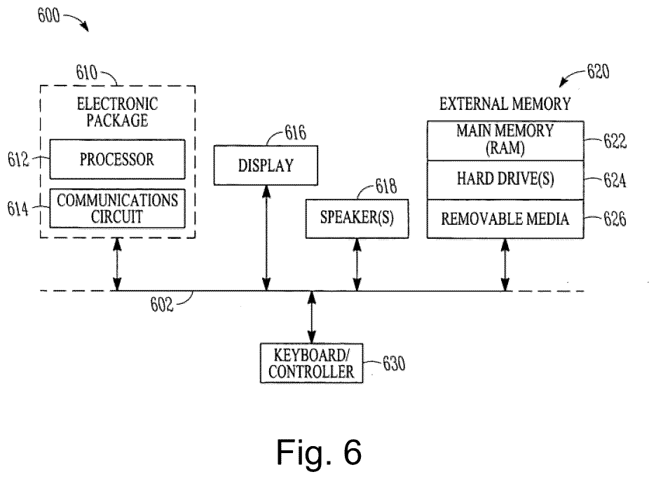

More details and aspects of the concept for offloading a workload may be described in connection with examples discussed above (e.g., FIGS. 1-4) or below (e.g., FIGS. 6-8).

FIG. 6 is a block diagram of an electronic apparatus 600 incorporating at least one electronic assembly and/or method described herein. Electronic apparatus 600 is-merely one example of an electronic apparatus in which forms of the electronic assemblies and/or methods described herein may be used. Examples of an electronic apparatus 600 include but are not limited to, personal computers, tablet computers, mobile telephones, game devices, MP3 or other digital music players, etc. In this example, electronic apparatus 600 comprises a data processing system that includes a system bus 602 to couple the various components of the electronic apparatus 600. System bus 602 provides communications links among the various components of the electronic apparatus 600. It may be implemented as a single bus, a combination of buses, or in any other suitable manner.

An electronic assembly 610 as describe herein may be coupled to system bus 602. The electronic assembly 610 may include any circuit or combination of circuits. In one embodiment, the electronic assembly 610 includes a processor 612, which may be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 610 are a custom circuit, an application-specific integrated circuit (ASIC), or the like, such as, for example, one or more circuits (such as a communications circuit 614) for use in wireless devices like mobile telephones, tablet computers, laptop computers, two-way radios, and similar electronic systems. The IC can perform any other type of function.

The electronic apparatus 600 may also include an external memory 620, which in turn may include one or more memory elements suitable to the particular application, such as a main memory 622 in the form of random access memory (RAM), one or more hard drives 624, and/or one or more drives that handle removable media 626 such as compact disks (CD), flash memory cards, digital video disk (DVD), and the like.

The electronic apparatus 600 may also include a display device 616, one or more speakers 618, and a keyboard and/or controller 630, which can include a mouse, trackball, touch screen, voice-recognition device, or any other device that permits a system user to input information into and receive information from the electronic apparatus 600.

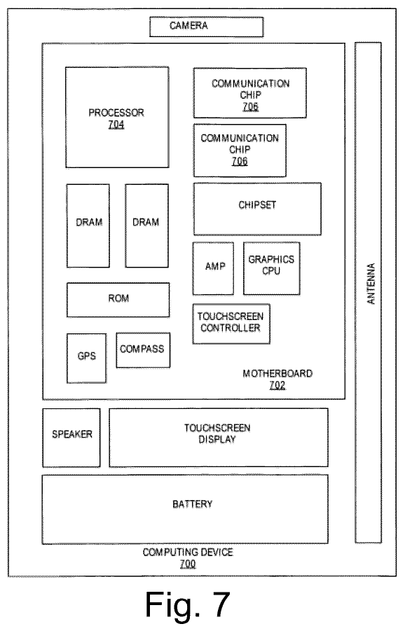

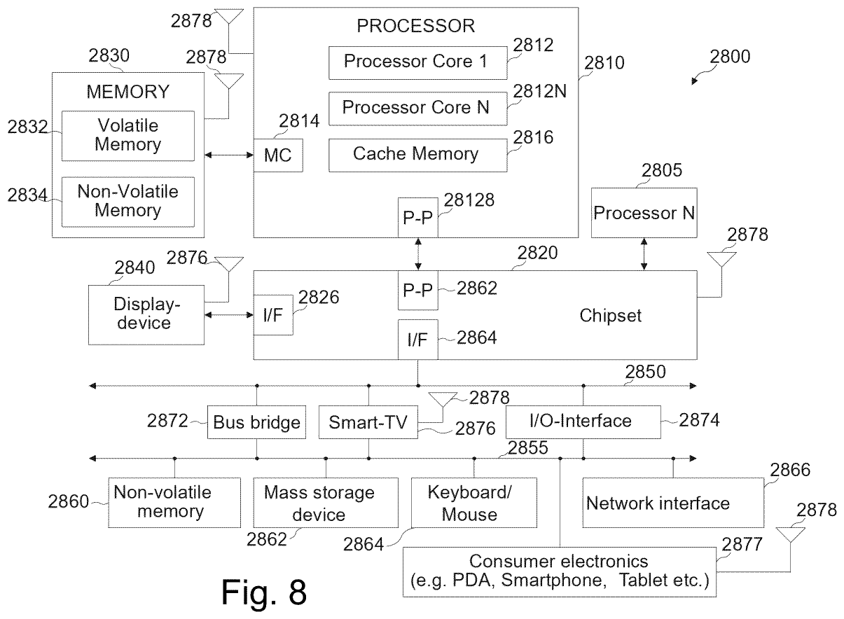

More details and aspects of the concept for offloading a workload may be described in connection with examples discussed above (e.g., FIGS. 1-5B) or below (e.g., FIGS. 7-8).

FIG. 7 illustrates a computing device 700 in accordance with one implementation of the invention. The computing device 700 houses a board 702. The board 702 may include a number of components, including but not limited to a processor 704 and at least one communication chip 706. The processor 704 is physically and electrically coupled to the board 702. In some implementations the at least one communication chip 706 is also physically and electrically coupled to the board 702. In further implementations, the communication chip 706 is part of the processor 704. Depending on its applications, computing device 700 may include other components that may or may not be physically and electrically coupled to the board 702. These other components include but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth). The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although, in some embodiments, they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter-range wireless communications such as Wi-Fi and Bluetooth, and a second communication chip 706 may be dedicated to longer-range wireless communications such as GPS, EDGE, GPRS, CDMA, WiMAX, LTE, Ev-DO, and others. The processor 704 of the computing device 700 includes an integrated circuit die packaged within the processor 704. In some implementations of the invention, the integrated circuit die of the processor includes one or more devices that are assembled in an cPLB- or cWLB-based POP package that includes a mold layer directly contacting a substrate, in accordance with implementations of the invention. The term “processor” may refer to any device or portion of a device that processes electronic data from registers and/or memory to transform that electronic data into other electronic data that may be stored in registers and/or memory. The communication chip 706 also includes an integrated circuit die packaged within the communication chip 706. In accordance with another implementation of the invention, the integrated circuit die of the communication chip includes one or more devices that are assembled in an ePLB- or eWLB-based POP package that includes a mold layer directly contacting a substrate, in accordance with implementations of the invention.

More details and aspects of the concept for offloading a workload may be described in connection with examples discussed above (e.g., FIGS. 1-6) or below (e.g., FIG. 8).

FIG. 8 shows an example of a higher-level device application for the disclosed embodiments. The MAA cantilevered heat pipe apparatus embodiments may be found in several parts of a computing system. In an embodiment, the MAA cantilevered heat pipe is part of a communications apparatus such as is affixed to a cellular communications tower. The MAA cantilevered heat pipe may also be referred to as an MAA apparatus. In an embodiment, a computing system 2800 includes but is not limited to, a desktop computer. In an embodiment, a system 2800 includes but is not limited to, a laptop computer. In an embodiment, a system 2800 includes but is not limited to, a netbook. In an embodiment, a system 2800 includes but is not limited to, a tablet. In an embodiment, a system 2800 includes but is not limited to, a notebook computer. In an embodiment, a system 2800 includes but is not limited to, a personal digital assistant (PDA). In an embodiment, a system 2800 includes but is not limited to, a server. In an embodiment, a system 2800 includes but is not limited to, a workstation. In an embodiment, a system 2800 includes but is not limited to, a cellular telephone. In an embodiment, a system 2800 includes but is not limited to, a mobile computing device. In an embodiment, a system 2800 includes but is not limited to, a smartphone. In an embodiment, a system 2800 includes but is not limited to, an internet appliance. Other types of computing devices may be configured with the microelectronic device that includes MAA apparatus embodiments.

In an embodiment, the processor 2810 has one or more processing cores 2812 and 2812N, where 2812N represents the Nth processor core inside processor 2810 where N is a positive integer. In an embodiment, the electronic device system 2800 using a MAA apparatus embodiment that includes multiple processors including 2810 and 2805, where the processor 2805 has logic similar or identical to the logic of the processor 2810. In an embodiment, the processing core 2812 includes, but is not limited to, pre-fetch logic to fetch instructions, decode logic to decode the instructions, execution logic to execute instructions, and the like. In an embodiment, the processor 2810 has a cache memory 2816 to cache at least one of instructions and data for the MAA apparatus in the system 2800. The cache memory 2816 may be organized into a hierarchal structure, including one or more levels of cache memory.

In an embodiment, the processor 2810 includes a memory controller 2814, which is operable to perform functions that enable the processor 2810 to access and communicate with memory 2830, which includes at least one of a volatile memory 2832 and a non-volatile memory 2834. In an embodiment, the processor 2810 is coupled with memory 2830 and chipset 2820. The processor 2810 may also be coupled to a wireless antenna 2878 to communicate with any device configured to at least one of transmit and receive wireless signals. In an embodiment, the wireless antenna interface 2878 operates in accordance with but is not limited to, the IEEE 802.11 standard and its related family, Home Plug AV (HPAV), Ultra Wide Band (UWB), Bluetooth, WiMax, or any form of wireless communication protocol.

In an embodiment, the volatile memory 2832 includes but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2834 includes but is not limited to, flash memory, phase change memory (PCM), read-only memory (ROM), electrically crasable programmable read-only memory (EEPROM), or any other type of non-volatile memory device.

The memory 2830 stores information and instructions to be executed by the processor 2810. In an embodiment, the memory 2830 may also store temporary variables or other intermediate information while the processor 2810 is executing instructions. In the illustrated embodiment, the chipset 2820 connects with processor 2810 via Point-to-Point (PtP or P-P) interfaces 2817 and 2822. Either of these PtP embodiments may be achieved using an MAA apparatus embodiment as set forth in this disclosure. The chipset 2820 enables the processor 2810 to connect to other elements in the MAA apparatus embodiments in a system 2800. In an embodiment, interfaces 2817 and 2822 operate in accordance with a PtP communication protocol such as the QuickPath Interconnect (QPI) or the like. In other embodiments, a different interconnect may be used.

In an embodiment, the chipset 2820 is operable to communicate with the processor 2810, 2805N, the display device 2840, and other devices 2872, 2876, 2874, 2860, 2862, 2864, 2866, 2877, etc. The chipset 2820 may also be coupled to a wireless antenna 2878 to communicate with any device configured to at least do one of transmit and receive wireless signals.

The chipset 2820 connects to the display device 2840 via the interface 2826. The display 2840 may be, for example, a liquid crystal display (LCD), a plasma display, a cathode ray tube (CRT) display, or any other form of visual display device. In an embodiment, the processor 2810 and the chipset 2820 are merged into an MAA apparatus in a system. Additionally, the chipset 2820 connects to one or more buses 2850 and 2855 that interconnect various elements 2874, 2860, 2862, 2864, and 2866. Buses 2850 and 2855 may be interconnected together via a bus bridge 2872 such as at least one MAA apparatus embodiment. In an embodiment, the chipset 2820 couples with a non-volatile memory 2860, a mass storage device(s) 2862, a keyboard/mouse 2864, and a network interface 2866 by way of at least one of the interface 2824 and 2874, the smart TV 2876, and the consumer electronics 2877, etc.

In an embodiment, the mass storage device 2862 includes, but is not limited to, a solid-state drive, a hard disk drive, a universal serial bus flash memory drive, or any other form of computer data storage medium. In one embodiment, the network interface 2866 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with but is not limited to, the IEEE 802.11 standard and its related family, Home Plug AV (HPAV), Ultra Wide Band (UWB), Bluetooth, WiMax, or any form of wireless communication protocol.

While the modules shown in FIG. 28 are depicted as separate blocks within the MAA apparatus embodiment in a computing system 2800, the functions performed by some of these blocks may be integrated within a single semiconductor circuit or may be implemented using two or more separate integrated circuits. For example, although cache memory 2816 is depicted as a separate block within processor 2810, cache memory 2816 (or selected aspects of 2816) may be incorporated into the processor core 2812.

Where useful, the computing system 2800 may have a broadcasting structure interface such as for affixing the MAA apparatus to a cellular tower.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules may be implemented as circuitry. A computing system referred to as being programmed to perform a method may be programmed to perform the method via software, hardware, firmware, or combinations thereof.

Any of the disclosed methods (or a portion thereof) may be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that may be executed by any computing system or device described or mentioned herein.

The computer-executable instructions or computer program products as well as any data created and/or used during implementation of the disclosed technologies may be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media may be contained in computer-readable storage devices such as solid-state drives, USB flash drives, and memory modules. Alternatively, any of the methods disclosed herein (or a portion) thereof may be performed by hardware components comprising non-programmable circuitry. In some examples, any of the methods herein may be performed by a combination of non-programmable hardware components and one or more processing units executing computer-executable instructions stored on computer-readable storage media.

The computer-executable instructions may be part of, for example, an operating system of the computing system, an application stored locally to the computing system, or a remote application accessible to the computing system (e.g., via a web browser). Any of the methods described herein may be performed by computer-executable instructions performed by a single computing system or by one or more networked computing systems operating in a network environment. Computer-executable instructions and updates to the computer-executable instructions may be downloaded to a computing system from a remote server.

Further, it is to be understood that implementation of the disclosed technologies is not limited to any specific computer language or program. For instance, the disclosed technologies may be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) may be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods may be used in conjunction with other methods. More details and aspects of the concept for adapting a processor to a workload may be described in connection with examples discussed above (e.g., FIGS. 1-7).

The aspects and features described in relation to a particular one of the previous examples may also be combined with one or more of the further examples to replace an identical or similar feature of that further example or to additionally introduce the features into the further example.

An example (e.g., example 1) relates to a scheduler apparatus comprising memory circuitry, machine-readable instructions, and processor circuitry to execute the machine-readable instructions to: identify a plurality of worker nodes within a cluster, where each worker node comprises a hardware-based security resource, receive a deployment request for an application deployment unit, wherein the deployment request includes a security requirement for a type of hardware-based security resource; select, based on the security requirement, a compatible worker node of the plurality of worker nodes, wherein the compatible worker node comprises the type of hardware-based security resource; and schedule the application deployment unit for execution on the compatible worker node.

Another example (e.g., example 2) relates to a previously described example (e.g., example 1), wherein the hardware-based security resource is a trusted execution environment (TEE).

Another example (e.g., example 3) relates to a previously described example (e.g., example 2), wherein the cluster comprises a plurality of types of TEEs.

Another example (e.g., example 4) relates to a previously described example (e.g., one of the examples 1-3), wherein the application deployment unit is at least one of: a pod; and a container.

Another example (e.g., example 5) relates to a previously described example (e.g., one of the examples 1-4), further comprising machine-readable instructions to receive worker node data from the plurality of worker nodes within the cluster.

Another example (e.g., example 6) relates to a previously described example (e.g., example 5), wherein worker node data includes the type of hardware-based security resource, a trusted memory size, a number of devices, and a number of supported keys.

Another example (e.g., example 7) relates to a previously described example (e.g., example 5), further comprising machine-readable instructions to update the worker node data based on a change of the hardware-based security resource in each worker node.

Another example (e.g., example 8) relates to a previously described example (e.g., example 5), wherein further comprising machine-readable instructions to: receive cluster data, wherein the cluster data includes at least one of: an addition of a new worker node to the cluster; and a removal of an existing worker node from the cluster.

Another example (e.g., example 9) relates to a previously described example (e.g., one of the examples 1-8), wherein the deployment request further includes a trusted memory size, a number of devices, and a number of supported keys.

Another example (e.g., example 10) relates to a previously described example (e.g., one of the examples 1-9), further comprising machine-readable instructions to receive security resource data from the compatible worker node after scheduling the application deployment unit.

Another example (e.g., example 11) relates to a previously described example (e.g., example 10), further comprising machine-readable instructions to reschedule the application deployment unit for execution on a second compatible worker node of the plurality of worker nodes when the security resource data no longer satisfies the security requirement.

Another example (e.g., example 12) relates to a previously described example (e.g., one of the examples 1-11), wherein a subset of the plurality of worker nodes comprise a plurality of hardware-based security resources.

An example (e.g., example 13) relates to a worker apparatus within a cluster, the apparatus comprising memory circuitry, one or more hardware-based security resources, machine-readable instructions, and processor circuitry to execute the machine-readable instructions to: provide security resource data for each of the one or more hardware-based security resources to a scheduling node; and receive an application deployment unit for execution on a compatible hardware-based security resource of the one or more hardware-based security resources.

Another example (e.g., example 14) relates to a previously described example (e.g., example 13), further comprising machine-readable instructions to provide updated hardware-based security resource data for each of the hardware-based security resources.

Another example (e.g., example 15) relates to a previously described example (e.g., one of the examples 13-14), further comprising machine-readable instructions to: determine whether the application deployment unit can execute in the compatible hardware-based security resource; and notify the scheduling node when the application deployment unit cannot execute in the compatible hardware-based security resource.

Another example (e.g., example 16) relates to a previously described example (e.g., one of the examples 13-15), wherein each hardware-based security resource is a trusted execution environment (TEE).

Another example (e.g., example 17) relates to a previously described example (e.g., one of the examples 13-16), relates to a previously described example (e.g., example 2), wherein the cluster comprises a plurality of types of TEEs.

Another example (e.g., example 18) relates to a previously described example (e.g., one of the examples 13-17), wherein the application deployment unit is at least one of: a pod; and a container.

Another example (e.g., example 19) relates to a previously described example (e.g., examples 13-18), wherein security resource data includes the type of hardware-based security resource, a trusted memory size, a number of devices, and a number of supported keys.

Another example (e.g., example 20) relates to a previously described example (e.g., examples 13-19), further comprising machine-readable instructions to update the scheduling node when the worker apparatus is added to the cluster and/or when the worker apparatus leaves the cluster.

Another example (e.g., example 21) relates to a previously described example (e.g., one of the examples 13-20), further comprising machine-readable instructions to provide the security resource data after receiving the application deployment unit.

An example (e.g., example 22) relates to a system and/or a cluster comprising a scheduler apparatus and/or a scheduler node according to a previously described example (e.g., one of the examples 1-12) and a worker apparatus and/or worker node according to a previously described example (e.g., one of the examples 13-21).

Another example (e.g., example 23) relates to a method for scheduling an application deployment unit on a compatible worker node within a cluster, the method comprising: identifying a plurality of worker nodes within a cluster, where each worker node comprises a hardware-based security resource, receiving a deployment request for the application deployment unit, wherein the deployment request includes a security requirement for a type of hardware-based security resource; selecting, based on the security requirement, the compatible worker node of the plurality of worker nodes, wherein the compatible worker node comprises the type of hardware-based security resource; and scheduling the application deployment unit for execution on the compatible worker node.

Another example (e.g., example 24) relates to a previously described example (e.g., example 23), wherein the hardware-based security resource is a trusted execution environment (TEE).

Another example (e.g., example 25) relates to a previously described example (e.g., example 24), wherein the cluster comprises a plurality of types of TEEs.

Another example (e.g., example 26) relates to a previously described example (e.g., one of the examples 23-25), wherein the application deployment unit is at least one of: a pod; and a container.

Another example (e.g., example 27) relates to a previously described example (e.g., one of the examples 23-26), further comprising receiving worker node data from the plurality of worker nodes within the cluster.

Another example (e.g., example 28) relates to a previously described example (e.g., example 27), wherein worker node data includes the type of hardware-based security resource, a trusted memory size, a number of devices, and a number of supported keys.

Another example (e.g., example 29) relates to a previously described example (e.g., example 27), further comprising updating the worker node data based on a change of the hardware-based security resource in worker each node.

Another example (e.g., example 30) relates to a previously described example (e.g., example 27), wherein further receiving cluster data, wherein the cluster data includes at least one of: an addition of a new worker node to the cluster; and a removal of an existing worker node from the cluster.

Another example (e.g., example 31) relates to a previously described example (e.g., one of the examples 23-20), wherein the deployment request further includes a trusted memory size, a number of devices, and a number of supported keys.

Another example (e.g., example 32) relates to a previously described example (e.g., one of examples 23-31), further comprising receiving security resource data from the compatible worker node after scheduling of the application deployment unit.

Another example (e.g., example 33) relates to a previously described example (e.g., example 32), further comprising rescheduling the application deployment unit for execution on a second compatible worker node of the plurality of worker nodes when the security resource data no longer satisfies the security requirement.

Another example (e.g., example 34) relates to a previously described example (e.g., one of the examples 23-33), wherein a subset of the plurality of worker nodes comprise a plurality of hardware-based security resources.

An example (e.g., example 35) relates a method for executing an application deployment unit on a worker apparatus, the method comprising: providing security resource data for each of the one or more hardware-based security resources to a scheduling node; and receiving an application deployment unit for execution on a compatible hardware-based security resource of the one or more hardware-based security resources.

Another example (e.g., example 36) relates to a previously described example (e.g., example 35), further comprising providing updated hardware-based security resource data for each of the hardware-based security resources.

Another example (e.g., example 37) relates to a previously described example (e.g., one of the examples 35-36), further comprising determining whether the application deployment unit can execute in the compatible hardware-based security resource; and notifying the scheduling node when the application deployment unit cannot execute in the compatible hardware-based security resource.

Another example (e.g., example 38) relates to a previously described example (e.g., one of the examples 35-37), wherein each hardware-based security resource is a trusted execution environment (TEE).

Another example (e.g., example 39) relates to a previously described example (e.g., one of the examples 35-38), relates to a previously described example (e.g., example 2), wherein the cluster comprises a plurality of types of TEEs.

Another example (e.g., example 40) relates to a previously described example (e.g., one of the examples 35-39), wherein the application deployment unit is at least one of: a pod; and a container.

Another example (e.g., example 41) relates to a previously described example (e.g., examples 35-40), wherein security resource data includes the type of hardware-based security resource, a trusted memory size, a number of devices, and a number of supported keys.

Another example (e.g., example 42) relates to a previously described example (e.g., examples 35-41), further comprising notifying the scheduling node when the worker apparatus is added to the cluster and/or when the worker apparatus leaves the cluster.

Another example (e.g., example 43) relates to a previously described example (e.g., one of the examples 35-42), further comprising providing the security resource data after receiving the application deployment unit.

Another example (e.g., example 44) relates to a previously described example (e.g., one of the examples 35-43), further comprising executing the application deployment unit on the hardware-based security resource.

An example (e.g., example 45) relates to a method for a system and/or a cluster comprising a scheduler apparatus and/or a scheduler node performing the method according to a previously described example (e.g., one of the examples 23-34) and a worker apparatus and/or worker node according to a previously described example (e.g., one of the examples 35-44).

An example (example 46) relates to a non-transitory, computer-readable medium comprising program code that, when the program code is executed on a processor, a computer, or a programmable hardware component, causes the processor, computer, or programmable hardware component to perform the method of a previously described example (e.g., one of the examples 23-44).

The aspects and features described in relation to a particular one of the previous examples may also be combined with one or more of the further examples to replace an identical or similar feature of that further example or to additionally introduce the features into the further example.

Examples may further be or relate to a (computer) program, including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable, or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means,” “means for providing a sensor signal,” “means for generating a transmit signal.”, etc., may be implemented in the form of dedicated hardware, such as “a signal provider,” “a signal processing unit,” “a processor,” “a controller,” etc. as well as hardware capable of executing software in association with the appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software but may include digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in a computer-readable medium and so executed by a computer or processor, whether or not such computer or processor is explicitly shown. Methods disclosed in the specification or in the claims may be implemented by a device having means for performing each of the respective acts of these methods.

It is further understood that the disclosure of several steps, processes, operations, or functions disclosed in the description or claims shall not be construed to imply that these operations are necessarily dependent on the order described unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes, or -operations.

If some aspects have been described in relation to a device or system, these aspects should also be understood as a description of the corresponding method. For example, a block, device, or functional aspect of the device or system may correspond to a feature, such as a method step, of the corresponding method. Accordingly, aspects described in relation to a method shall also be understood as a description of a corresponding block, a corresponding element, a property, or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules may be implemented as circuitry. A computing system referred to as being programmed to perform a method may be programmed to perform the method via software, hardware, firmware, or combinations thereof.

Any of the disclosed methods (or a portion thereof) may be implemented as computer-executable instructions or a computer program product (e.g., machine-readable instructions, program code, etc.). Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that may be executed by any computing system or device described or mentioned herein.

The computer-executable instructions may be part of, for example, an operating system of the computing system, an application stored locally to the computing system, or a remote application accessible to the computing system (e.g., via a web browser). Any of the methods described herein may be performed by computer-executable instructions performed by a single computing system or by one or more networked computing systems operating in a network environment. Computer-executable instructions and updates to the computer-executable instructions may be downloaded to a computing system from a remote server.

Further, it is to be understood that implementation of the disclosed technologies is not limited to any specific computer language or program. For instance, the disclosed technologies may be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) may be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect, feature, or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although, in the claims, a dependent claim refers to a particular combination with one or more other claims, other examples may also include a combination of the dependent claim with the subject matter of any other dependent or independent claim. Such combinations are hereby explicitly proposed unless it is stated in the individual case that a particular combination is not intended. Furthermore, features of a claim should also be included for any other independent claim, even if that claim is not directly defined as dependent on that other independent claim.

1. A scheduler apparatus comprising memory circuitry, machine-readable instructions, and processor circuitry to execute the machine-readable instructions to:
identify a plurality of worker nodes within a cluster, where each worker node comprises a hardware-based security resource,
receive a deployment request for an application deployment unit, wherein the deployment request includes a security requirement for a type of hardware-based security resource;
select, based on the security requirement, a compatible worker node of the plurality of worker nodes, wherein the compatible worker node comprises the type of hardware-based security resource; and
schedule the application deployment unit for execution on the compatible worker node.

2. The scheduler apparatus of claim 1, wherein the hardware-based security resource is a trusted execution environment (TEE).

3. The scheduler apparatus of claim 2, wherein the cluster comprises a plurality of types of TEEs.

4. The scheduler apparatus of claim 1, wherein the application deployment unit is at least one of:
a pod; and
a container.

5. The scheduler apparatus of claim 1, further comprising machine-readable instructions to receive worker node data from the plurality of worker nodes within the cluster.

6. The scheduler apparatus of claim 5, wherein worker node data includes the type of hardware-based security resource, a trusted memory size, a number of devices, and a number of supported keys.

7. The scheduler apparatus of claim 5, further comprising machine-readable instructions to update the worker node data based on a change of the hardware-based security resource in each worker node.

8. The scheduler apparatus of claim 5, wherein further comprising machine-readable instructions to:
receive cluster data, wherein the cluster data includes at least one of:
an addition of a new worker node to the cluster; and
a removal of an existing worker node from the cluster.

9. The scheduler apparatus of claim 1, wherein the deployment request further includes a trusted memory size, a number of devices, and a number of supported keys.

10. The scheduler apparatus of claim 1, further comprising machine-readable instructions to receive security resource data from the compatible worker node after scheduling of the application deployment unit.

11. The scheduler apparatus of claim 10, further comprising machine-readable instructions to reschedule the application deployment unit for execution on a second compatible worker node of the plurality of worker nodes when the security resource data no longer satisfies the security requirement.

12. The scheduler apparatus of claim 1, wherein a subset of the plurality of worker nodes comprise a plurality of hardware-based security resources.

13. A worker apparatus within a cluster, the apparatus comprising memory circuitry, one or more hardware-based security resources, machine-readable instructions, and processor circuitry to execute the machine-readable instructions to:
provide security resource data for each of the one or more hardware-based security resources to a scheduling node; and
receive an application deployment unit for execution on a compatible hardware-based security resource of the one or more hardware-based security resources.

14. The worker apparatus of claim 13, further comprising machine-readable instructions to provide updated hardware-based security resource data for each of the hardware-based security resources.

15. The worker apparatus of claim 13, further comprising machine-readable instructions to:
determine whether the application deployment unit can execute in the compatible hardware-based security resource; and
notify the scheduling node when the application deployment unit cannot execute in the compatible hardware-based security resource.

16. The worker apparatus of claim 13, wherein each hardware-based security resource is a trusted execution environment (TEE).

17. The worker apparatus of claim 13, wherein the application deployment unit is at least one of:
a pod; and
a container.

18. A method for scheduling an application deployment unit on a compatible worker node within a cluster, the method comprising:
identifying a plurality of worker nodes within a cluster, where each worker node comprises a hardware-based security resource,
receiving a deployment request for the application deployment unit, wherein the deployment request includes a security requirement for a type of hardware-based security resource;
selecting, based on the security requirement, the compatible worker node of the plurality of worker nodes, wherein the compatible worker node comprises the type of hardware-based security resource; and
scheduling the application deployment unit for execution on the compatible worker node.

19. A non-transitory, computer-readable medium comprising a program code that, when the program code is executed on a processor, a computer, or a programmable hardware component, causes the processor, computer, or programmable hardware component to perform the method of claim 18.
